(19) United States
(12) Patent Application Publication
(10) Pub. No.: US 2014/0352985 A1
(43) Pub. Date: Dec. 4, 2014

(54) Self-Regulating Foam Dispensing System

(71) Applicants: John E. McLoughlin, Hauppage, NY (US); Neocles G. Athanasiades, Setauket, NY (US); Kiam Meng Toh, St. James, NY (US)

(72) Inventors: John E. McLoughlin, Hauppage, NY (US); Neocles G. Athanasiades, Setauket, NY (US); Kiam Meng Toh, St. James, NY (US)

(21) Appl. No.: 13/903,064

(22) Filed: May 28, 2013

(51) Int. Cl. A62C 5/02

(52) U.S. Cl. CPC A62C 5/022
USPC 169/13

(57) ABSTRACT

A pumping apparatus comprising an engine-driven primary pump and a discharge system is provided with a hydraulically driven additive injection system. The additive injection system includes at least one vessel containing an additive, a delivery conduit for transporting the additive from the vessel to the discharge system, and an additive pump for pumping the additive from the vessel to the discharge system via the delivery conduit. The additive pump is preferably a centrifugal pump driven by a hydraulic turbine mounted within the discharge system downstream of the primary pump.

### BACKGROUND

1. Field of the Invention

This invention relates to the field of firefighting equipment. More particularly, the invention relates to a compressed air foam system for pumping foam concentrate into a stream of water, aerating the foam-water mixture, and discharging the aerated foam-water mixture through a high-pressure nozzle.

In a further and more specific aspect, the invention concerns a compressed air foam system wherein the amount of air and foam concentrate injected into the system is automatically regulated by the amount of water discharged by the pump.

2. Description of the Prior Art

Water is the best-known but by no means the most effective agent for extinguishing fires. Fires involving flammable liquids and gas, for instance, should never be extinguished with a solid stream of water because this can actually cause the fuel to scatter and the flames to spread. For this reason, various types of foams have been developed for cooling and smothering the flames. In some firefighting systems, the foam is induced by injecting foam concentrate into either the suction side or the discharge side of the fire pump. Other systems induce foam in the hose line through an in-line Venturi, sucking fluid from 5-gallon pails. Still other systems induce foam at the nozzle using the “DDT sprayer” principle, which involves blowing air across a vertical tube leading from the foam receptacle to create a low pressure region, thereby sucking foam out of the receptacle by the Bernouli effect, and then atomizing and spraying the foam.

A major drawback of many prior-art foam dispensing systems is that precise control systems are required to keep the ratio of foam concentrate to water constant. These controls increase the cost and complexity of the systems, making them impractical for use by small, underfunded fire departments.

Accordingly, it is an object of the present invention to provide an system for injecting an additive into a stream of fluid being discharged from a pump and for maintaining the additive at a constant proportion with respect to the fluid, without requiring complex controls.

Another object of the invention is to provide a self-regulating foam-dispensing system that can inject foam concentrate into a stream of water, maintain the foam concentrate and water mixture at a constant ratio, and inject compressed air into the mixture to produce an aerated foam.

Still another object of the invention is to provide a self-regulating foam-dispensing system that is inexpensive to manufacture and can easily be retrofitted into a pre-existing pumping system.

### SUMMARY OF THE INVENTION

Briefly, to achieve the desired objects of the invention, a pumping apparatus comprising an engine-driven primary pump and a discharge system is provided with a hydraulically driven additive injection system. The additive injection system includes at least one vessel containing an additive, a delivery conduit for transporting the additive from the vessel to the discharge system, and an additive pump for pumping the additive from the vessel to the discharge system via the delivery conduit. The additive pump is preferably a centrifugal pump driven by a hydraulic turbine mounted within the discharge system downstream of the primary pump.

In a preferred embodiment of the invention, the primary pump comprises a fire-engine pump and the additive injection system comprises one or more foam pumps for injecting foam concentrate into a foam-mixing segment of the discharge system. An air compressor is also provided for injecting compressed air into an air mixing segment located downstream of the foam-mixing segment. The foam pumps are centrifugal pumps and the air compressor is a centrifugal compressor, all sharing a shaft with a hydraulic turbine or reverse centrifugal pump that is powered by the energy of the water flowing through the discharge line of the primary pump. Because of their common shaft, the hydraulic turbine, the foam pumps, and the air compressor all operate at the same speed. Thus, any increase or decrease in the volume of water flowing through the discharge system results in a results in a proportionate increase or decrease in the volume of foam concentrate and air injected into the system. No additional flow controls are needed. However, microprocessor-controlled valves may be provided in the foam and air conduits if extra precision is desired.

### BRIEF DESCRIPTION OF THE DRAWINGS

The foregoing and more specific objects and advantages of the instant invention will become readily apparent to those skilled in the art from the following detailed description of the preferred embodiments thereof taken in conjunction with the drawings in which:

FIG. 1 is a schematic view showing the self-powered foam system of the present invention; and

FIG. 2 is a control block diagram of an alternate embodiment of the system.

### DETAILED DESCRIPTION OF THE PREFERRED EMBODIMENT

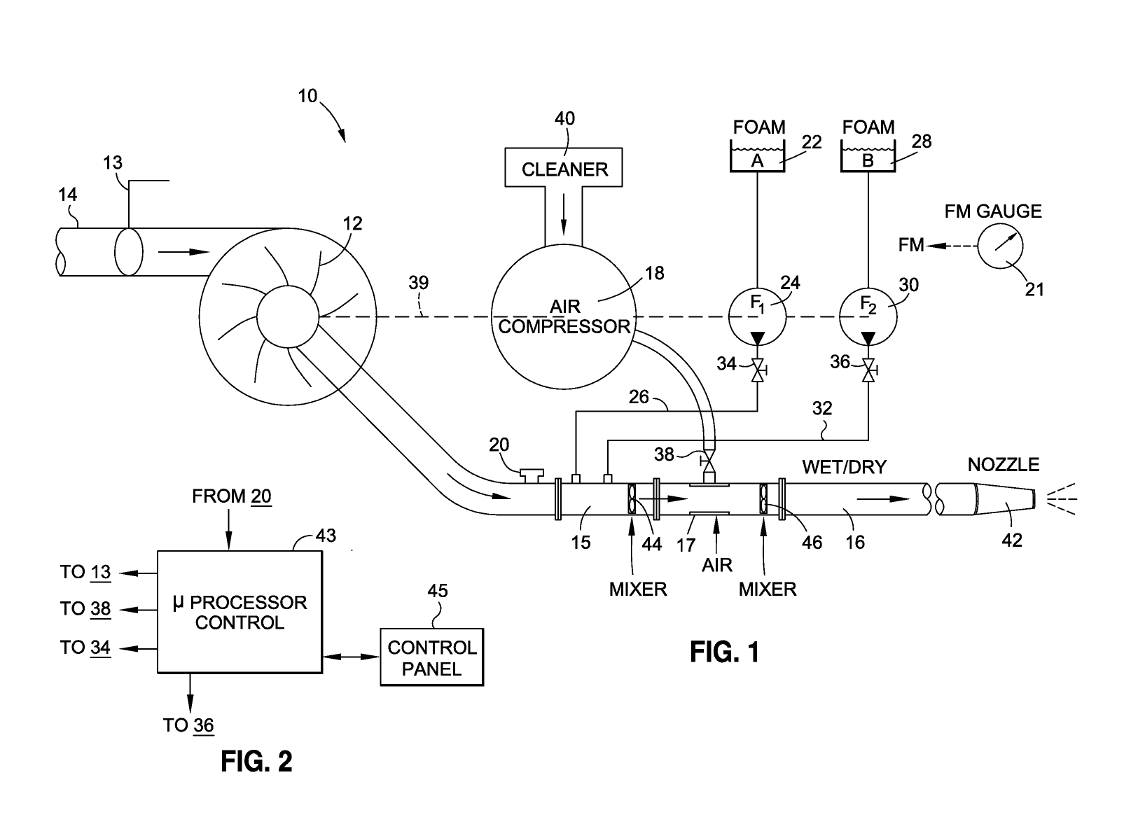

Turning now to the drawings, attention is first directed to FIG. 1, which shows the self-powered foam system of the present invention indicated in its entirety by the numeral 10.

The system 10 comprises a hydraulic motor or super-charger 12 positioned between the discharge line 14 of a fire engine pump (not shown) and a hose or set of hoses 16 for spraying water at a fire. A water control valve 13 is provided between the pump and the supercharger 12 for controlling the flow of water into the system. Each hose 16 includes a foam mixing segment 15 where the water from the fire engine pump can mix with different types of foam concentrates, such as, for instance, Class A foam concentrate suitable for fighting wildfires and structural fires, or Class B foam concentrate suitable for extinguishing flammable liquid fires. Downstream of the foam mixing segment 15 is an air mixing segment 17 where compressed air from an air compressor 18 is injected into the water-foam concentrate mixture, creating fully aerated foam. The system preferably also includes a flow meter 20 for measuring the amount of water induced into the system, and for displaying this information on a gauge 21 on the fire truck dashboard or elsewhere.

Separate foam delivery systems may be provided for each type of foam concentrate. For instance, Class A foam concentrate may be stored in a first foam tank 22 and pumped by a first foam pump 24 through a first foam conduit 26 leading to the foam-mixing segment 15. Similarly, Class B foam concentrate may be stored in a second foam tank 28 and pumped by a second foam pump 30 through a second foam conduit 32 leading to the foam-mixing segment 15. Furthermore, each foam conduit 26, 32 may be provided with a foam control valve 34, 36, respectively, for controlling the volume of concentrate delivered to the foam-mixing segment 15.

Similarly, an air control valve 38 may be provided for controlling the volume of air injected into the air mixing segment 17. In addition, the air compressor 18 is preferably provided with an air cleaner 40 for filtering smoke and the like out of the ambient air, so that it can be used to resuscitate victims of smoke-inhalation.

The hydraulic motor or super-charger 12 of the present invention consists of a hydraulic turbine or reverse centrifugal pump with contoured blades. It is powered by the energy of the water flowing through the discharge line 14 of the pump, and shares a drive shaft 39 with the air compressor 18 and foam pumps 24, 30. Thus, the rate of compressed air and foam concentrate flowing into the system is proportional to the flow rate of the water going through the pump, which in turn is proportional to the cross-sectional area of the hose or hoses 16 and the pressure of the pump and discharge nozzle 42. This eliminates the need for precise mixing controls of the type currently found on many fire vehicles.

In the simplest embodiment of the invention, no further controls are needed, since the amount of air and foam concentrate injected into the system is automatically regulated by the amount of water discharged by the pump. However, in the alternate embodiment shown in the control diagram of FIG. 2, output signals FM1 from the flow meter 20 may be input into a microprocessor 43 in the fire truck's control panel 45, which then drives the water, foam, and air control valves, 13, 34, 36, and 38, respectively, to achieve a more precise mixture.

In summary, the system operates as follows. When the water control valve 13 is open, water in the discharge line 14 of the pump flows into the hydraulic motor 12, exerting a force on the blades of the motor 12 and causing the drive shaft 39 to spin, in turn actuating both the air compressor 18 and the foam pumps 24 and 30. The water then flows into the foam-mixing segment 15 of the fire hose 16, where it mixes with foam concentrate from one or more of the foam tanks 22, 28. Next, it passes through a first mixing plate 44 where turbulence is induced, allowing mixing to take place most efficiently. Then, the water-foam concentrate mixture enters the air-mixing segment 17 where it mixes with compressed air from the air compressor 18. After passing through a second mixing plate 46 where turbulence is once again induced, the fully aerated foam is then discharged through the nozzle 42 at a rate determined by the firefighter.

Various modifications and variations to the embodiments herein chosen for purposes of illustration will readily occur to those skilled in the art. To the extent that such modifications and variations do not depart from the spirit of the invention, they are intended to be included within the scope of thereof.

Having fully described the invention in such clear and concise terms as to enable those skilled in the art to understand and practice the same, the invention claimed is:

1. A pumping apparatus comprising:
an engine;
a primary pump driven by said engine, the primary pump including a supply side and a discharge side;
a discharge system coupled to the discharge side of the primary pump for dispensing a fluid therefrom;
at least one vessel containing an additive;
a delivery conduit for transporting said additive from the vessel to a first entry point in the discharge system where said fluid and said additive combine to form a mixture;
an additive pump positioned within the delivery conduit for pumping the additive from the vessel to the discharge system via the delivery conduit; and
hydraulic drive means located in the discharge system for converting energy from the flow of the primary fluid into power for driving the additive pump.

2. The pumping apparatus according to claim 1, wherein;
said additive pump is a centrifugal pump;
said hydraulic drive means is a reverse centrifugal pump; and
said centrifugal pump and said reverse centrifugal pump share a common shaft.

3. The pumping apparatus according to claim 1, wherein said fluid is water, said additive is a foam concentrate, and said mixture is a foam-water mixture.

4. The pumping apparatus according to claim 4, further comprising air injector means for injecting air into the discharge system at a point downstream of the entry point and aerating the the foam-water mixture.

5. The pumping apparatus according to claim 5, wherein said air injector means comprises an air compressor driven by said hydraulic drive means.

6. The pumping apparatus according to claim 6, wherein;
said air injector comprises a rotary air compressor;
said hydraulic drive means is a reverse centrifugal pump; and
said rotary air compressor and said reverse centrifugal pump share a common shaft.

7. The pumping apparatus according to claim 6, wherein
said additive pump is a centrifugal pump; and
said centrifugal pump, said rotary air compressor, and
said reverse centrifugal pump share a common shaft.

8. The pumping apparatus according to claim 1, further comprising :
a second vessel containing a second additive;
a second delivery conduit for transporting said second additive from the second vessel to a second entry point in the discharge system where said fluid and said second additive combine to form a mixture;
a second additive pump positioned within the second delivery conduit for pumping the second additive from the second vessel to the discharge system via the second delivery conduit;
wherein said hydraulic drive powers the second additive pump.

10. The pumping apparatus according to claim 8, wherein the first and second additive pumps are centrifugal pumps sharing a common shaft.

11. The pumping apparatus according to claim 1, further comprising electronic control means for controlling the amount of additive delivered to the discharge system.

12. The pumping apparatus according to claim 1, wherein the electronic control means comprises a microprocessor-controlled valve.

13. The pumping apparatus according to claim 1, further comprising a valve located in said delivery conduit for controlling the amount of additive delivered to the discharge system.

14. The pumping apparatus according to claim 13, further comprising:
a flow meter for measuring the flow of said fluid in said discharge system; and
electronic control means for manipulating said valve in response to changes in the flow of said fluid as measured by said flow meter.

16. A foam-dispensing system comprising:
an engine-driven pump including a supply side and a discharge side;
a hose coupled to the discharge side of the pump;
a foam concentrate tank;
a delivery conduit for transporting foam concentrate from the foam concentrate tank to the hose;
a foam pump positioned within the delivery conduit for drawing the foam concentrate from the foam concentrate tank into the hose; and
hydraulic drive means located in the hose for converting energy from the flow of liquid in the hose into power for driving the foam pump.

17. The foam-dispensing system according to claim 16, wherein;
said foam pump is a centrifugal pump;
said hydraulic drive means is a reverse centrifugal pump; and
said centrifugal pump and said reverse centrifugal pump share a common shaft.

18. The foam-dispensing system according to claim 16, further comprising air injector means for injecting air into the hose to aerate the the foam-water mixture.

19. The foam-dispensing system according to claim 18, wherein:
said delivery conduit is fluidly coupled to said hose at a first entry point; and
said air injector means comprises a rotary compressor injecting air into the hose at a second entry point downstream of the first entry point.

20. The foam-dispensing system according to claim 19, further comprising a mixing plate located in said hose intermediate said first and second entry points for inducing turbulence in the foam-water mixture before the mixture is aerated.

21. A pumping apparatus comprising:
an engine-driven pump including a supply side and a discharge side;
a hose coupled to the discharge side of the pump for dispensing a fluid therefrom;
a rotary air compressor; and
hydraulic drive means located in the hose for converting energy from the flow of fluid in the hose into power for driving the air compressor.

22. The pumping apparatus according to claim 21, further comprising:
at least one vessel containing an additive;
a delivery conduit for transporting said additive from the vessel to a first entry point in the hose where said fluid and said additive combine to form a mixture; and
an additive pump driven by the hydraulic drive means and positioned within the delivery conduit for pumping the additive from the vessel to the hose via the delivery conduit.

23. The pumping apparatus according to claim 22, wherein:
said hydraulic drive means is a reverse centrifugal pump;
said additive pump is a centrifugal pump; and
said reverse centrifugal pump, said centrifugal pump, and said rotary air compressor share a common shaft.

24. The pumping apparatus according to claim 22, wherein said air compressor is configured to inject air into said hose at a location downstream of said first entry point for the purpose of aerating said mixture.

25. The pumping apparatus according to claim 21, wherein said air compressor further comprises an air cleaner for filtering ambient air so that the ambient air can be safely administered to victims of smoke-inhalation.
